(19) United States
(12) Patent Application Publication
(10) Pub. No.: US 2010/0188714 A1
(43) Pub. Date: Jul. 29, 2010

(54) Image inspection system, image inspection method, and computer-readable medium storing an image inspection program

(75) Inventor: Shinji Yamakawa, Kawasaki city (JP)

Correspondence Address: Harness, Dickey & Pierce P.L.C., P.O. Box 8910, Reston, VA, 20195, US

(73) Assignee: Ricoh Company, Ltd.

(21) Appl. No.: 12/654,632

(22) Filed: Dec. 28, 2009

(30) Foreign Application Priority Data
Dec. 25, 2008 (JP) 2008-329913

(51) Int. Cl. H04N 1/46

(52) U.S. Cl. 358/504

(57) ABSTRACT

An image inspection system inspects quality of image prepared from source image data by an image forming apparatus. The image inspection system includes a scanner, a storage unit, an inspection color designating unit, an inspection area determination unit, a reference color extraction unit, an inspection color extraction unit, and an image quality judgment unit. The scanner scans reference and inspection document to prepare reference and inspection image data. The inspection color designating unit designates an inspection color. The inspection area determination unit extracts an inspection area having the inspection color from the source image data. The reference color extraction unit extracts an image having first-extracted-color from the reference image data. The inspection color extraction unit extracts an image having a second-extracted-color from the inspection image data. The image quality judgment unit compares the first and second-extracted-colors to determine image quality of the inspection document image.

### CROSS-REFERENCE TO RELATED APPLICATIONS

This application claims priority to Japanese Patent Application No. 2008-329913, filed on Dec. 25, 2008 in the Japan Patent Office, which is hereby incorporated by reference herein in its entirety.

### BACKGROUND OF THE INVENTION

1. Field of the Invention

The present invention relates to an image inspection system or apparatus that inspects an image recorded on a recording medium (typically in sheet form) using an image forming apparatus, and more particularly, an image inspection system or apparatus that inspects an image output on a sheet, a method of inspecting an image output on a sheet, and a computer-readable medium storing a program for executing such method of inspecting an image output on a sheet.

2. Description of the Background Art

Image forming apparatuses such as printers and multifunctional apparatuses, which may be known as multifunctional peripherals (MFP), have been widely used to output (print) images on a sheet of paper or other recording media based on electronic or digitized data, wherein the images may be documents, pictures, text, characters, or the like. It is known that such image forming apparatuses may output images of different levels of image quality (e.g., color tone) even if the same image data is used, due to variation in certain characteristics among image forming apparatuses and even in the same image forming apparatus over time. Such phenomena may be referred to as performance variation, due either to apparatus-to-apparatus characteristics variation or same-apparatus characteristics variation over time.

Such image quality variation in printed images produced from the same image data is not desirable. Accordingly, as described below, several methods for inspecting image quality have been proposed in which, for example, a printed image is compared with a reference image for inspecting image quality. Such image quality inspection may be typically important for a commercial printing industry, which needs to produce printing materials (e.g., catalogues, brochures, direct mails) in large scale because such printing materials may need higher image quality that can satisfy needs of customers.

In JP-2005-342936-A, a digitized image prepared before printing (i.e., reference image) is compared with a scanned image on a sheet, which is another digitized image (i.e., inspection target image) prepared after printing an image. A control point for managing the color tone is selected from the inspection target image. Then, a comparison result of the two images is used to control the color tone of the image. In such process, the suitability of the selected control point is determined by interpreting inspection target image data.

Further, in JP-2004-351814-A, an image printed on a sheet (e.g., paper) is scanned after a printing operation, the scanned image is compared with a reference image, and a comparison result is used to control the color tone of the image to be printed. In such process, representative points in an image are selected to compare image data. Such representative points may be selected and determined by a user. For example, a user may use a display screen of control panel to select representative points.

Further, JP-H08-265586-A (i.e., JP-3577128-B) discloses an image processing apparatus such as a digital copier in which a document used for color balance adjustment is scanned to generate scanned image data of a full-color image, and such scanned image data is input to the image processing apparatus. The scanned image data is processed and then the full-color image is printed. The printed full-color image is scanned and the scanned image is input as scanned image data of the printed full-color image to the image processing apparatus, and is compared with scanned image data of an original prepared before printing by designating a given area for image inspection. Based on such comparison result, a condition of color processing can be adjusted.

In the above-described methods, image data is scanned from a sheet, which is an output from an image forming apparatus, and the image processing operation performed by the image forming apparatus is adjusted and controlled based on results of a comparison between the reference image data and the scanned image data. Such methods are to some extent successful in reducing the above-mentioned image quality variation caused by apparatus characteristics variation of image forming apparatuses, which may vary among image forming apparatuses, and may vary for the same image forming apparatus over time.

However, in JP-2005-342936-A, inspection image data scanned from an output image of an image forming apparatus may have some scanning characteristics variation. If such inspection image is compared with the reference image data, precise comparison may be hard to attain.

Further, in JP-2004-351814-A, a user uses a display screen of the control panel to select and determine representative points by visual inspection. Accordingly, the user may overlook image concentration variation if such variation exists. If appropriate representative points are not selected, a precise comparison may be hard to attain.

Further, in JP-3577128-B, a test printing is required to adjust color image processing, wherein such test printing is conducted using a document prepared for color balance adjustment. Such test printing may need to be performed in an adjustment mode of image forming apparatus, which is different from a normal printing mode of image forming apparatus, thus adversely affecting output performance of the image forming apparatus.

### SUMMARY

In one aspect of the present invention, an image inspection system is devised. The image inspection system for conducting an image inspecting operation to inspect image quality of a document image prepared by an image forming apparatus using source image data is devised. The image inspecting operation is conductable by preparing a reference document image and an inspection document image from the source image data. The image inspection system includes a scanner, a storage unit, an inspection color designating unit, an inspection area determination unit, a reference color extraction unit, an inspection color extraction unit, and an image quality judgment unit. The scanner scans the reference document image to prepare reference image data and scans the inspection document image to prepare an inspection image data. The storage unit stores at least the source image data. The inspection color designating unit designates at least one inspection color selectable from colors included in the source image data. The inspection area determination unit extracts an image that is drawn by the inspection color from the source image data stored in the storage unit, and sets a one area in the extracted image as an inspection area. Coordinate data of the inspection area is used for the image inspecting operation. The reference color extraction unit extracts an image from the reference image data at a position in the reference image data corresponding to the inspection area set by the inspection area determination unit. The extracted image includes a first-extracted-color corresponding to the inspection color. The first-extracted-color is used as a reference color for the image inspecting operation. The inspection color extraction unit extracts an image from the inspection image data at a position in the inspection image data corresponding to the inspection area set by the inspection area determination unit. The extracted image includes a second-extracted-color corresponding to the inspection color. The image quality judgment unit determines whether an image quality of the inspection document image is acceptable by comparing the first-extracted-color and the second-extracted-color and determining whether a difference in image quality of the first-extracted-color and the second-extracted-color is within a given range.

In another aspect of the present invention, a method of inspecting image quality of document image prepared by an image forming apparatus using source image data is devised. The method includes the steps of preparing, preparing, storing, selecting, extracting, setting, scanning, extracting, scanning, extracting, comparing, and determining. In the preparing, a reference document image is prepared with the image forming apparatus using the source image data. In the preparing, an inspection document image is prepared with the image forming apparatus using the source image data. In the storing, the source image data is stored in a storage unit. In the selecting, at least one color included in the source image data is selected as an inspection color used for an image inspecting operation. In the extracting, an image that is drawn by the inspection color is extracted from the source image data stored in the storage unit. In the setting, a one area in the extracted image drawn by the inspection color is set as an inspection area. In the scanning, the reference document image is scanned using a scanner to prepare reference image data. In the extracting, an image is extracted from the reference image data at a position in the reference image data corresponding to the inspection area. The extracted image includes a first-extracted-color used as reference color for an image inspecting operation. In the scanning, the inspection document image is scanned using the scanner to prepare inspection image data. In the extracting, an image is extracted from the inspection image data at a position in the inspection image data corresponding to the inspection area. The extracted image includes a second-extracted-color used for the image inspecting operation. In the comparing, the first-extracted-color and the second-extracted-color are compared. In the determining, it is determined whether an image quality of the inspection document image is acceptable by determining whether a difference in image quality of the first-extracted-color and the second-extracted-color is within a given range.

In another aspect of the present invention, a computer-readable medium storing a program for inspecting image quality of document image prepared by an image forming apparatus using source image data is devised. The program includes instructions that when executed by a computer causes the computer to execute a method of inspecting image level of document image. The method includes the steps of preparing, preparing, storing, selecting, extracting, setting, scanning, extracting, scanning, extracting, comparing, and determining. In the preparing, a reference document image is prepared with the image forming apparatus using the source image data. In the preparing, an inspection document image is prepared with the image forming apparatus using the source image data. In the storing, the source image data is stored in a storage unit. In the selecting, at least one color included in the source image data is selected as an inspection color used for an image inspecting operation. In the extracting, an image that is drawn by the inspection color is extracted from the source image data stored in the storage unit. In the setting, a one area in the extracted image drawn by the inspection color is set as an inspection area. In the scanning, the reference document image is scanned using a scanner to prepare reference image data. In the extracting, an image is extracted from the reference image data at a position in the reference image data corresponding to the inspection area. The extracted image includes a first-extracted-color used as reference color for an image inspecting operation. In the scanning, the inspection document image is scanned using the scanner to prepare inspection image data. In the extracting, an image is extracted from the inspection image data at a position in the inspection image data corresponding to the inspection area. The extracted image includes a second-extracted-color used for the image inspecting operation. In the comparing, the first-extracted-color and the second-extracted-color are compared. In the determining, it is determined whether an image quality of the inspection document image is acceptable by determining whether a difference in image quality of the first-extracted-color and the second-extracted-color is within a given range.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates, a schematic configuration an image inspection system according to an example embodiment, in which an image inspection apparatus and an inspection-target image forming apparatus are included;

FIG. 2 illustrates an example block diagram of a scanner correction unit of the image forming apparatus of FIG. 1;

FIG. 3 illustrates an example block diagram of a printer correction unit of the image forming apparatus of FIG. 1;

FIG. 4 illustrates an example block diagram of a controller of the image forming apparatus of FIG. 1, in which image data is input and output from and to a network;

FIG. 5 illustrates an example block diagram of a scanner correction unit of the image inspection apparatus of FIG. 1;

FIG. 6 illustrates an example block diagram of a controller of the image inspection apparatus of FIG. 1, in which image data is input and output with an external apparatus;

FIG. 7 illustrates an example image inspection configuration conducted by the controller of image inspection apparatus of FIG. 1;

FIG. 8 shows a flowchart of image inspecting operation performed by the image inspection apparatus of FIG. 1; and

FIG. 9 schematically shows image data to be used to determine an inspection area.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, Operations, elements, and/or components, but do not preclude the presence or addition of one or more other features, integers, steps, Operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner.

Referring now to the drawings, an image inspection system, an image inspection apparatus, and an image inspection method according to an example embodiment are described.

In an example embodiment, an image forming apparatus to be inspected may be a printing apparatus such as multifunctional peripherals (MFP), for example, but not limited these. The to-be-inspected image forming apparatus may be referred to as an inspection-target image forming apparatus, or simply, an image forming apparatus. Such image forming apparatus may have function of copier, facsimile, printer, scanner, and a document box function, for example. The document box function may have a function of outputting image stored in the image forming apparatus at a given timing such re-outputting of the same image. Further, the image forming apparatus may be used to output color images using color printing function. These functions can be used to input image data into the image forming apparatus. For example, an image on a document sheet can be scanned by a scanner, by which image data can be input to the image forming apparatus; when image data is input from an external apparatus via a communication unit, electronic image data (to be used as print data) is input to the image forming apparatus. Such input image data may be processed as image data, which can be used for various purposes. Such image data may be referred to as general-purpose image data. The general-purpose image data may be used as data for an image outputting operation by a plotter, or transmitted to an external apparatus (e.g., PC, facsimile) for some purposes.

In an example embodiment, an inspection target is an output image prepared from source image data, which may be prepared with a given format of general-purpose image data. The image may be output (or printed) on a recording sheet (e.g., paper) using an image forming apparatus such as a plotter, a printing apparatus (e.g., printer), for example.

Output image output by an image forming apparatus may have an image quality variation due to variation of apparatus characteristics or change of apparatus characteristics. By observing such image quality variation or change, performance variation of image forming apparatus caused by “apparatus-to-apparatus characteristics variation” or “over-time-characteristics-variation of same apparatus” can be checked or monitored.

An image inspection can be conducted as below. An inspection-target image forming apparatus output an image on a sheet as an inspection document. Then, inspection image data is prepared from the inspection document, and compared with reference image data to obtain a comparison result of two image data as “comparison result.” Then, it is determined whether the comparison result is within a given range to judge image quality such as for example color tone of inspection image. Based on judgment result of image quality, it is determined whether the inspected image has passed the inspection criteria, and then the inspection result signal is transmitted. Further, the judgment result of image quality is transmitted to the inspection-target image forming apparatus as a signal, which may indicate necessity of adjusting or correcting imaging condition, by which a condition adjustment can be conducted for the inspection-target image forming apparatus, as required.

The image inspection method according to an example embodiment may have following aspects, for example. In one aspect, a source image data is prepared or generated. Then, an inspection document and reference document are prepared using the source image data. The inspection document is prepared using an inspection-target image forming apparatus, and the reference document is prepared using the inspection-target image forming apparatus. As described later, the inspection-target image forming apparatus may be used to produce the inspection document and reference document. The inspection document and reference document are scanned by a scanner of an image inspection apparatus to prepare an inspection image data and reference image data. Such inspection image data and reference image data are compared each other. In another aspect, the inspection image data and reference image data are compared each other by setting a given inspection area having a given color. Specifically, a given inspection color is selected from the source image data, and then an image area having the selected inspection color is extracted, by which the extracted image area can be set as an inspection area. As such, the inspection color and the inspection area may be set based on the source image data, which may be preferable for image inspection because the source image data is originally prepared data, which means the accuracy of data property can be secured at a higher precision. Accordingly, an image inspection can be conducted more precisely. Such inspection area is set for inspection image data and reference image data. Then, color information at the inspection area in the inspection image data and reference image data is extracted. The extracted color information of the inspection image data and reference image data are compared each other.

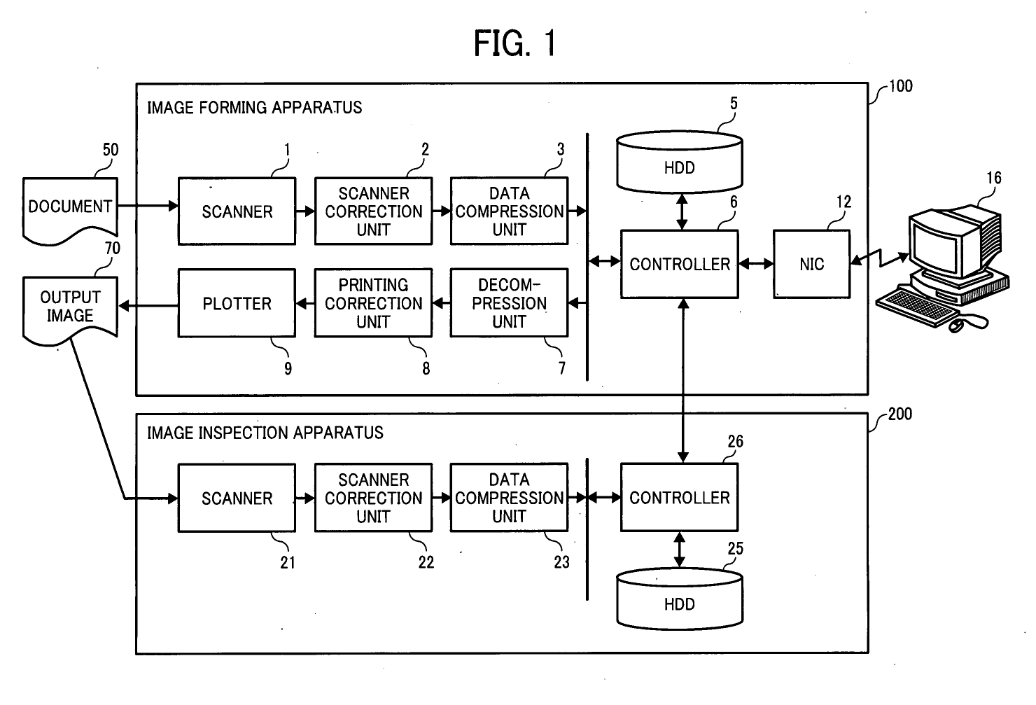

FIG. 1 illustrates a schematic configuration of image inspection system according to an example embodiment, in which an image forming apparatus 100 and an image inspection apparatus 200 may be included, wherein the image forming apparatus 100 is an inspection target apparatus. The image forming apparatus 100 may be used as multifunctional peripherals (MFP), for example, but not limited these. FIG. 1 mainly illustrates an example configuration of data processing system for the image forming apparatus 100 (e.g., printing apparatus) and the image inspection apparatus 200.

The image forming apparatus 100 shown in FIG. 1 may include a scanner 1, and a network interface controller 12 (NIC 12), through which image data may be input to the image forming apparatus 100. Specifically, an image (e.g., document image) is scanned by the scanner 1 to generate image data, and then the image data is input to the image forming apparatus 100; an external apparatus such as personal computer 16 (PC 16) outputs image data to the image forming apparatus 100 via the NIC 12, and the image data input to the image forming apparatus 100 is processed, and then the plotter 9 outputs an image. The external apparatus is not limited to a personal computer, but other units or apparatus can be used. Such data input to the image forming apparatus 100 from the external apparatus may be printing data generated by a printer driver of the PC 16, or data received from a facsimile, for example.

Further, in the data processing system of the image forming apparatus 100, input images can be stored in a storage unit having a large storage capacity such as hard disk drive 5 (HDD 5), for example. Such stored image data can be further used for conducting a printing operation, or such stored image data can be transmitted to an external apparatus as image data (e.g., data transmission), for example.

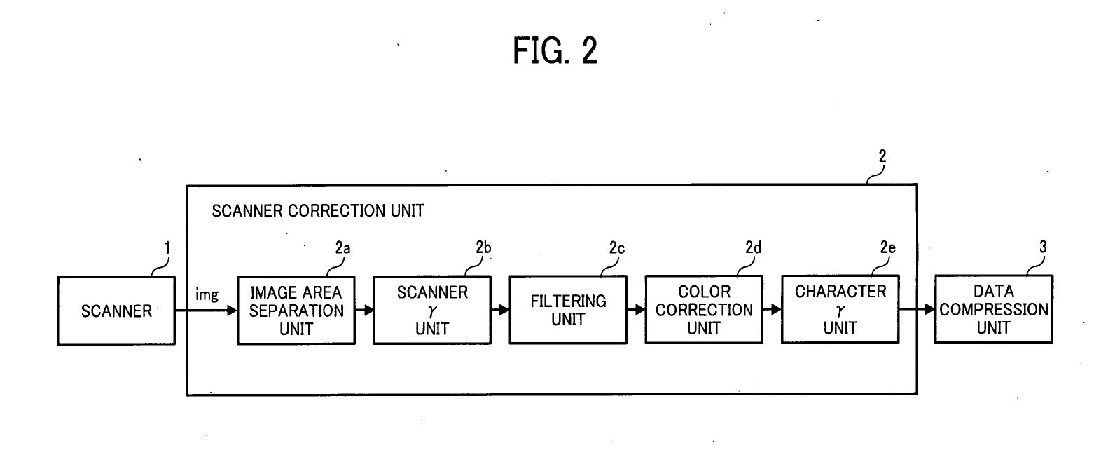

The scanner 1 may include a line sensor composed of photoelectric transducer such as charge coupled device (CCD), an analog/digital (A/D) converter, and a drive circuit, for example. When a document is set and scanned by the scanner 1, grayscale information of RGB (R:RED, G:GREEN, B:BLUE) component of document image is obtained, and then digitized image data of RGB is generated and output as image data having a given bit such as 8-bit. The scanner 1 is connected to a scanner correction unit 2, and the scanner correction unit 2 is connected to a data compression unit 3. The scanner correction unit 2 receives the digitized image data from the scanner 1 and then processes the digitized image data with a given procedure set in advance and outputs the image data after conducting the given procedure, which is to be described later with reference to FIG. 2.

Typically, when the scanner 1 scans a document, image data is input to the scanner 1, wherein such image data property may be dependent on apparatus property of the scanner 1. The scanner correction unit 2 removes or reduces signal components which may depend on apparatus property of the scanner 1, canonicalizes the image data, converts the image data to general-purpose image data, and then stores the general-purpose image data in the HDD 5, for example. The general-purpose image data may be compressed by the data compression unit 3, as required, when the general-purpose image data is to be stored in the HDD 5. Such data compression process may be employed to handle data efficiently.

When the compressed data stored in the HDD 5 is used for image outputting process (e.g., printing operation) by the plotter 9, the compressed data is decompressed using a decompression unit 7. Specifically, the compressed image data is read from the HDD 5 of the controller 6, and then decompressed by the decompression unit 7. Then, the decompressed data is processed by a printing correction unit 8 so that the data can be used for image outputting process (e.g., printing operation) by the plotter 9.

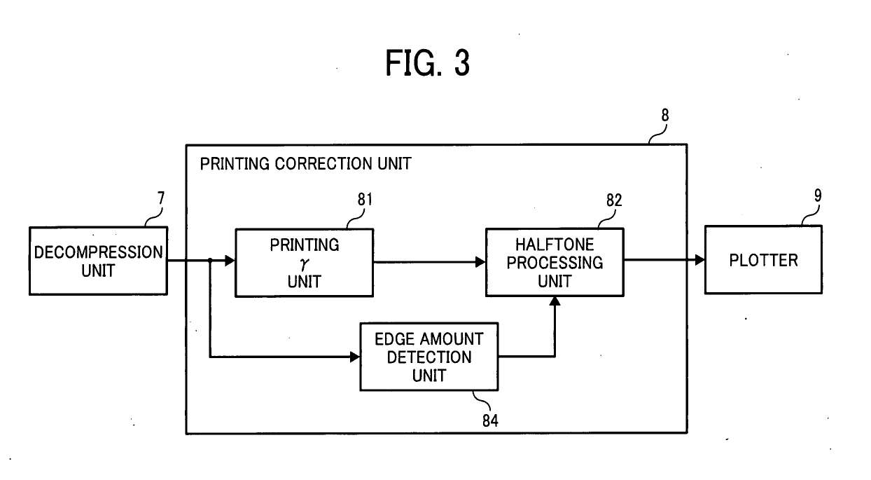

When image data is received from an external apparatus via the NIC 12 and the controller 6, the image data is processed as general-purpose image data, and then the general-purpose image data is processed with a similar manner for image data stored in the HDD 5. The printing correction unit 8 may conduct image-condition adjustment or user-instructing adjustment process to concerned image data. The printing correction unit 8 will be described in detail later with reference to FIG. 3.

The HDD 5 is used as a storage device, which may have a large storage capacity for storing digitized image data and image management data associated to the digitized image data (e.g., bibliographic information). Although the HDD 5 is used as storage device having large storage capacity in an example embodiment, other storage devices can be similarly used. For example, a silicon disk using flash memory having greater storage capacity can be used, and such silicon disk may reduce power consumption and increase an access speed.

The controller 6 may control a data processing system of the image forming apparatus 100 as a whole. The controller 6 may include a central processing unit (CPU), a read only memory (ROM), and a random access memory (RAM) as hardware configuration. The ROM stores software (or program), and the RAM is used as a working memory for running a program under a control of the central processing unit (CPU). The ROM may store a program used for image outputting process by the plotter 9, which is instructed by a print command from the image forming apparatus 100. The ROM may store another program used for outputting source image data when the image forming apparatus 100 outputs image and when an image inspecting-operation is to be conducted by the image inspection apparatus 200, which will be described later. The CPU may control operations and processes using such program or the like.

A description is now given to an image output operation of the image forming apparatus 100, which is interrelated with the image inspection apparatus 200 to be described later.

When a copying function of image forming apparatus 100 is used, the plotter 9 may be used to conduct an image outputting process or operation. For example, the scanner 1 scans image data from a document 50, and converts the scanned image data (e.g., analog signal) to digital data having a given resolution such as for example 600 dpi (dot per inch), and outputs the converted image data to the scanner correction unit 2. The scanner correction unit 2 converts or corrects digital image data from the scanner 1 as general-purpose image data, which can be used for various types of output operation such as copying function.

FIG. 2 illustrates an example schematic configuration of the scanner correction unit 2. As shown in FIG. 2, the scanner correction unit 2 may include an image area separation unit 2a, a scanner γ unit 2b, a filtering unit 2c, a color correction unit 2d, and a character γ unit 2e, for example.

The image area separation unit 2a receives image data “img” having linear reflection coefficient from the scanner 1. The image area separation unit 2a separates pixels of image into three pixel areas; black text edge area; non-black color text edge area; and picture area. Such image area separation method can be conducted by a known method described in JP-2003-259115-A, for example, in which signals of any one of black text edge area, non-black color text edge area, and picture area is assigned to each of pixels as image area separation signal of image data.

The scanner γ unit 2b converts image data having linear reflection coefficient to image data of linear concentration. The filtering unit 2c switches a filtering process for image data based on the image area separation signal obtained by the image area separation unit 2a to maintain property of original document image. Specifically, for the text area such as black text edge area, non-black color text edge area, sharpness processing is conducted for enhancing legibility. Further, in the picture area, sudden concentration change in image data is recognized as edge amount, and a smoothing processing and/or sharpness processing is conducted in view of edge amount. The sharpness processing may be conducted for the sudden edge to enhance legibility of letters in a picture. The color correction unit 2d converts RGB data to CMY data using a masking method such as primary concentration masking method or the like except black text edge area. To enhance color reproduction of image data, common area of CMY (C:cyan, M:magenta, Y:yellow) data is processed by Under Color Replacement (UCR) to generate K (black) data, by which CMYK data can be output.

As for the black text edge area, when the scanner 1 scans RGB image with a deviation from a correct scan position, black letter in document may be reproduced as non-black colored image due to a scan position deviation, or when YMCK images are printed by the plotter 9 and YMCK images are superimposed while positional deviations from a correct position occurs, legibility may deteriorate. Accordingly, only the black letter area may be output as single color data of K (black), wherein the single color data of K corresponds to luminance of black letter. The character γ unit 2e enhance γ factor for color letter and black letter to enhance contrast of letter area.

As shown in FIG. 1, the data compression unit 3 conducts a compression processing to YMCK image data processed in the scanner correction unit 2, and transmits compressed data to a bus, wherein YMCK image data may be 8-bit image data for each color. After receiving the compression processing, the compressed image data is transmitted to the controller 6 via a bus. The controller 6 may include a semiconductor memory to store the compressed image data.

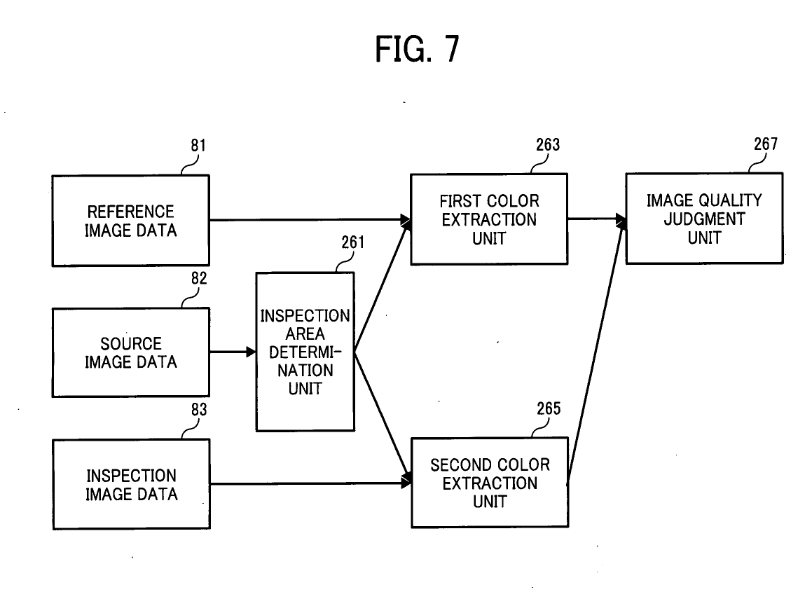

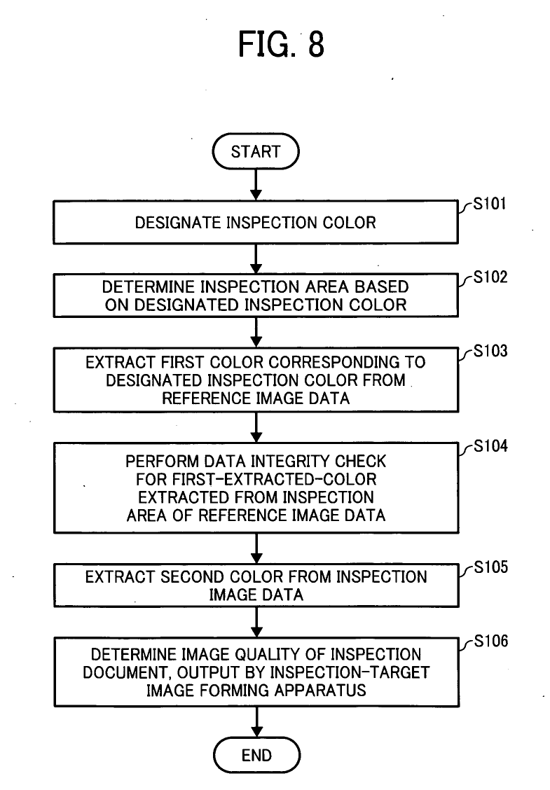

In an example embodiment, the controller 6 may supply source image data used for image inspection to the image inspection apparatus 200 to be described later. When a scanner-input image is used as source image data, the scanner-input image is stored in a semiconductor memory. Then, as described later with reference to FIGS. 7 and 8, the controller 6 uses a given designated image as inspection-purpose image. Then the controller 6 extracts inspection area using coordinate data from the source image data (to be described later), and transmits extracted image area data to the controller 26 in the image inspection apparatus 200.

In another case, the image forming apparatus 100 may only transmit source image data to the image inspection apparatus 200, and then the image inspection apparatus 200 may extract an inspection area from the source image data.

Further, when general-purpose RGB data is used as source image data for extracting the inspection area, the color correction unit 2d conducts a color conversion process for the general-purpose RGB data, and then such general-purpose RGB data is used for an extraction process of the inspection area.

In an example embodiment, scanner-input image stored in the semiconductor memory may be stored in the HDD 5 so that the scanner-input image can be used again at a later time. Although the input image data is compressed in the above configuration, if a bus has a broader band width and the HDD 5 has a larger storage capacity, the input image data may be handled without compression.

A description is now given to an image outputting process using the plotter 9. Specifically, the controller 6 reads the scanner-input image stored in the HDD 5, and then transmits the scanner-input image to the decompression unit 7 via the bus. The decompression unit 7 decompresses the compressed image data into original YMCK data (e.g., 8-bit image data for YMCK), and transmits the YMCK data to the printing correction unit 8. The printing correction unit 8 conducts conversion and/or correction processing to each of YMCK data separately, wherein such processed YMCK data are used as image data when the plotter 9 conducts image outputting process. FIG. 3 shows one example configuration of the printing correction unit 8. As shown in FIG. 3, the printing correction unit 8 may include a printing γ unit 81, a halftone processing unit 82, and an edge amount detection unit 84, for example. The printing γ unit 81 implements γ correction to image data received from the decompression unit 7 in view of frequency characteristics of the plotter 9. The halftone processing unit 82 implements grayscale correction to image data by performing quantization process such as dithering process, error diffusion process, or the like. The edge amount detection unit 84 detects sudden concentration change in image data as edge amount. The printing γ unit 81 implements γ conversion to image data in view of frequency characteristics of the plotter 9, wherein γ characteristics is set to a given level so that outputs from the plotter 9 can become standardized data.

The halftone processing unit 82 converts image data from 8-bit image data to 2-bit image data for each of colors using an error diffusion process and/or dithering process in view of grayscale characteristics of plotter 9 and edge amount. For example, such quantization process may be conducted as follows: Based on detection amount of the edge amount detection unit 84, an extraction process is performed for black text image, and extracted black text image signal may be used to increase contrast of black text image. With such process, legibility of text such as letters, characters, or the like can be enhanced.

The printing correction unit 8 prepares image data to be used in the plotter 9 for image outputting process, and transmits the image data to the plotter 9. The plotter 9 may be an image transfer unit using a laser beam for image writing process, in which 2-bit image data received from the printing correction unit 8 may be used for writing a latent image on a photoconductor, and then the latent image is developed as toner image, and the toner image is transferred to a transfer sheet to form an image, by which copying process ends.

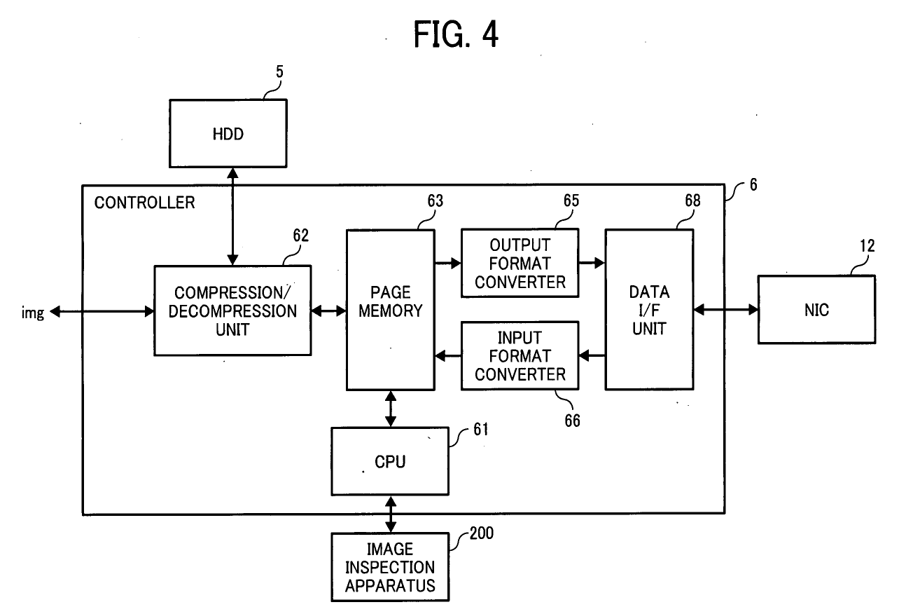

The plotter 9 may be used as a printer (i.e., printing function) using the PC 16 and network for image outputting process. When the PC 16 transmits image data to the controller 6 via the NIC 12, the controller 6 analyzes commands for imaging and printing operation, and generates image data of bitmap format to be used for image printing based on an analysis result. FIG. 4 shows an example block diagram of the controller 6, in which the controller 6 communicates with a network for inputting/outputting image data. The controller 6 may include a CPU 61, a compression/decompression unit 62, a page memory 63, an output format converter 65, an input format converter 66, and a data interface (I/F) unit 68, as shown in FIG. 4.

The controller 6 receives commands and data for imaging and printing from an external apparatus such as PC 16 for an image outputting process.

The data I/F unit 68 analyzes command associated to data received by the NIC 12, and generate RGB image data formatted in general-purpose image format such as JPEG (Joint Photographic Experts Group), TIFF (tagged image file format) based on an analysis result, and outputs image data formatted with general-purpose image format to the input format converter 66.

The input format converter 66 implements a color conversion process to convert RGB data to CMYK data, and converts image data of JPEG or TIFF format to original image data (e.g., 8-bit image data) of each color, and writes image data to the page memory 63. YMCK image data stored in the page memory 63 may be stored in the HDD 5. Such YMCK image data stored in the HDD 5 may be read-out when YMCK image data is used for image outputting process by the plotter 9. In such process, image data is compressed by the compression/decompression unit 62, and then output to and stored in the HDD 5.

On one hand, YMCK image data in the page memory 63 can be used for image outputting process by the plotter 9 without such compression process, in which image data is output from the page memory 63 to a bus as image data “img,” and then receives given image processing for image outputting by the plotter 9 (to be described later), and used as data for printing operation.

Further, such compressed image data may be transmitted to an external apparatus such as for example PC 16. Specifically, compressed image data read-out from the HDD 5 or a bus is decompressed by the compression/decompression unit 62 as 8-bit image data for each color, and then the decompressed image data is stored in the page memory 63. Then, image data is output to the output format converter 65. The output format converter 65 implements color conversion process to convert CMYK data to RGB data, converts format of image data to general-purpose image format such as JPEG, TIFF format, or the like. The data I/F unit 68 receives data from the output format converter 65, outputs data to the NIC 12 by converting data type matched to the NIC 12.

As such, the controller 6 receives image data from a network and converts the image data to YMCK data, which can be used for image outputting process by the plotter 9, and such image data may be stored in the HDD 5. Then, such YMCK data can be read-out from the HDD 5, and receives an image processing for generating image data (e.g., processing in the decompression unit 7 and the printing correction unit 8) used for image outputting process by the plotter 9. Such image data processing is similar to image data processing for the above-described copying operation using scanner-input image as image data for image outputting process by the plotter 9. The detail of such image data processing is described as above for copying operation.

Further, as described later, when an image data to be used for image inspection conducted by the image inspection apparatus 200 is input to the controller 6 via a network, the controller 6 extracts an inspection area (expressed by coordinate data) from source image data, as similar to the above described scanner-input image, and transmits the extracted inspection area data to a controller 26 in the image inspection apparatus 200, which will be described later.

The image inspection apparatus 200 may include a given configuration to conduct an image inspecting operation according to an example embodiment. The image inspection apparatus 200 may inspect an image formed on a sheet output by the image forming apparatus 100. The image forming apparatus 100 may be used as an inspection target apparatus. Such image formed on the sheet may be referred to as an “inspection document.” For example, the image forming apparatus 100 outputs the inspection document using the plotter 9. Then, the “inspection document” is converted to image data as inspection image data. The inspection image data is compared with reference image data. Then, based on a comparison result of inspection image data and reference image data, the image inspection apparatus 200 determines image quality of image output by the image forming apparatus 100. The image quality may be color tone of image, but not limited these.

In an example embodiment, the image inspection apparatus 200 may generate the reference image data to be compared with the inspection image data, wherein the inspection image data may be prepared from an image output on a sheet, which is output by the image forming apparatus 100. To prepare such reference image data and inspection image data, the image inspection apparatus 200 may include a scanner 21, a scanner correction unit 22, a compression processing unit 23, a controller 26, and a HDD 25 as shown in FIG. 1. The scanner 21 scans images from the image output on a sheet, which is produced by the image forming apparatus 100. The scanner correction unit 22 processes data scanned by the scanner 21 to convert the data to general-purpose image data. The compression processing unit 23 is used to store the general-purpose image data prepared by the scanner correction unit 22. The controller 26 controls the image inspection apparatus 200 as a whole. The controller 26 compares the inspection image data and reference image data to determine image quality (e.g., color tone) of inspection document image, wherein the inspection image data may be generated from a document image processed by a data inputting process such as processing by the scanner 21 and the scanner correction unit 22. The HDD 25 stores such image data, which is to be used for image inspecting operation.

The reference image data, which is to be compared with the inspection image data, may be prepared as below. The reference image data may be prepared by the image forming apparatus 100 using the source image data, which is also used for producing the inspection document data. The image forming apparatus 100 can be used to produce a reference document in addition to produce an inspection document. For example, a user may judge image quality (e.g., color tone) produced by the image forming apparatus 100 by checking printed image on a sheet. When the user judges a printed image as acceptable level, such printed image may be used as “reference document.” When the image forming apparatus 100 is used for producing images on a number of sheets (e.g., brochures), the user needs to confirm whether the image quality (e.g., color tone) of images can be maintained at a given acceptable level, which is set by the reference document. The user may check whether the image quality (e.g., color tone) of images printed on sheets against the reference document. Accordingly, printed sheets to be checked for image quality may be referred to as “inspection document.” As such, based on the source image data, the image forming apparatus 100 can be used to produce a reference document and an inspection document.

By using the source image data, the image forming apparatus 100 produces an image on a sheet as a reference document, and then the reference document is scanned by the scanner 21 to prepare the reference image data. In an example embodiment, any image can be used as the source image data, which is different from conventional methods that may need to use a specially-prepared test image pattern such as color patch image.

As above described, the source image data is used to produce both of the reference document and the inspection document. After producing the reference document as above described, the source image data is stored and used to produce the inspection document. Further, the source image data is used to determine an inspection area, which will be described later. Accordingly, in an example embodiment, the source image data may be stored in the HDD 5 of the image forming apparatus 100, for example.

A description is now given to a process of image inspecting operation using the image inspection apparatus 200. In one case, performance variation of apparatus due to characteristics variation of one apparatus over time can be inspected as below. An image inspecting operation, which checks or monitors performance variation due to characteristics variation of a same apparatus over time which may occur during a printing (or outputting) process of the image forming apparatus 100, may be conducted as below. The printing process of the image forming apparatus 100 may be mainly conducted using the HDD 5, plotter 9, and others.

At first, source image data is set and used for outputting an image on a sheet by activating the plotter 9 of the image forming apparatus 100. Then, the source image data used for outputting image on sheet is stored in the HDD 5. At a given timing, an image inspecting operation may be conducted, in which the source image data stored in the HDD 5 may be used again to output an image on a sheet. By performing such image outputting, a reference document can be prepared in a first printing operation and an inspection document can be prepared in a second printing operation, in which the first printing operation may be an operation for printing a reference document, and second printing operation may be an operation for printing an inspection document. The first printing operation and second printing operation can be conducted at any timing in view of operation condition of the image forming apparatus 100. For example, when one image forming apparatus is used for a printing operation in large scale such as catalogue printing, the first printing operation may be conducted at first when such large scale printing operation is to be conducted, and the second printing operation may include subsequent printing operation during such large scale printing operation. Further, when a plurality of image forming apparatuses is employed for a printing operation in large scale, the first printing operation may be conducted by one image forming apparatus, and the second printing operation may be conducted by other image forming apparatuses.

Such reference document and inspection document are scanned by the scanner 21 of the image inspection apparatus 200 to prepare reference image data and inspection image data. The reference image data and scanned inspection image data are compared each other to detect variation of image quality (e.g., color tone) between the reference image data and inspection image data as “difference of image data”, by which performance variation due to characteristics variation of apparatus over time can be checked or monitored.

On one hand, “performance variation due to apparatus-to-apparatus characteristics variation” of apparatuses can be inspected as below. Such checking or monitoring may be required because “performance variation due to apparatus-to-apparatus characteristics variation” may occur when a plurality of image forming apparatuses of the same type is used for image forming operation using the same image data, for example. Such checking or monitoring may be conducted as below. When “performance variation due to apparatus-to-apparatus characteristics variation” of two image forming apparatuses is checked or monitored, one apparatus is used as a reference apparatus, and another apparatus is used an inspection target apparatus. Then, source image data, which is common data for two apparatuses, is used to output an image on a sheet. The common data may be source image data stored in one apparatus, which is also accessible from another apparatus. By performing such image outputting, a reference document is prepared using the reference apparatus and an inspection document is prepared using the inspection target apparatus. Such reference document and inspection document are scanned by the scanner 21 of the image inspection apparatus 200 to prepare reference image data and inspection image data. The reference image data and the inspection image data are compared each other to detect variation of image quality (e.g., color tone) between the reference image data and inspection image data as “difference of image data,” to check or monitor “performance variation due to apparatus-to-apparatus characteristics variation.”

Further, an inspection area used for image inspecting operation is determined based on the source image data. A process of determining inspection area is to be described later. For example, the inspection area may be selected and determined from the source image data stored in the image forming apparatus 100, and the image forming apparatus 100 transmits the determined inspection area data to the image inspection apparatus 200.

The controller 26 of the image inspection apparatus 200 may use a communication unit or data transmission unit to receive the inspection area data from the image forming apparatus 100. For example, the communication unit or data transmission unit may be disposed between the controller 6 of the image forming apparatus 100 and the controller 26 of the image inspection apparatus 200 to send and receive the data therebetween. In example embodiment, the inspection area may be determined by the image forming apparatus 100, but the inspection area can also be determined by the image inspection apparatus 200, in which source image data stored in the image forming apparatus 100 is transmitted to the image inspection apparatus 200 to determine the inspection area by the image inspection apparatus 200.

The controller 26 controls data processing system of the image inspection apparatus 200 as a whole, and may include a hardware configuration of CPU, ROM, and RAM, in which the CPU runs a software program, the ROM stores a program, and the RAM is used as a working memory when a program is run, for example. The ROM may store a program for conducting an image inspecting operation, wherein such program is used to generate inspection-image-related data and reference-image-related data and to implement an image inspecting operation when an image inspecting operation is requested to the image inspection apparatus 200. Such process to be described later (see process flow of FIG. 8) is controlled by the CPU. Such program can be stored in any recording medium such as ROM, and disc-recording medium such as HDD, CD (Compact Disk)-ROM, MO (Magnet Optical Disk), but not limited thereto.

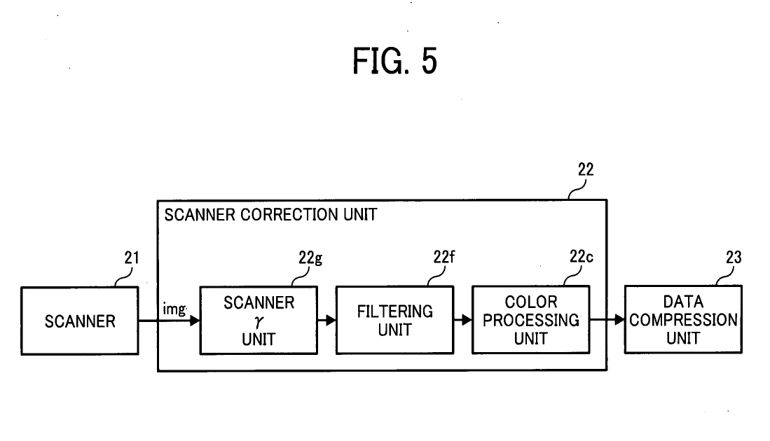

A description is now given to processing in the image inspection apparatus 200. The image forming apparatus 100 outputs an image on a sheet as an “output image 70” using source image data. The scanner 21 scans the output image 70 as a document image composed of analog RGB image signals, converts the scanned analog RGB image signals to digital image data, and outputs the digital image data to the scanner correction unit 22. The scanner correction unit 22 may include a scanner γ unit 22g, a filtering unit 22f, and a color correction processing unit 22c as shown in FIG. 5, for example.

The scanner 21 inputs image data “img” having a given linear reflection coefficient to the scanner γ unit 22g, and then the scanner γ unit 22g converts image data from linear reflection coefficient data to linear concentration data. The filtering unit 22f switches a filtering process using image area separation signal obtained at an image area separation unit (not shown) to maintain characteristics of document image. Accordingly, as for picture area, sudden concentration change in image data may be detected as edge amount, and based on the edge amount, smoothing processing and/or sharpness processing are implemented in the filtering unit 22f. The sharpness processing is conducted for the sudden edge to enhance legibility of text such as letters in a picture. Further, the color correction processing unit 22c converts RGB data received from the filtering unit 22f to general-purpose RGB data. By converting data to general-purpose RGB data, image inspection can be conducted easily. The compression processing unit 23 receives 8-bit image data of RGB data from the scanner correction unit 22, then compresses the image data, and then transmits the image data to the controller 26 via a bus. The controller 26 may include a semiconductor memory or the like to store data. In an example embodiment, scanner-input image data stored in a semiconductor memory is then stored in the HDD 25 so that the scanner-input image data can be used as reference image data and inspection image data to be used for image inspecting operation. Although such scanner-input image data may receive a compression process, such compression process can be omitted if a bus has a broader bandwidth and the HDD 25 has a greater capacity for storage, in which data can be used without compressing data.

The controller 26 receives data from the image forming apparatus 100, which is an external apparatus for the controller 26, and also transmits data to the image forming apparatus 100. For example, the controller 26 may receive inspection area data from the image forming apparatus 100, and transmit result of image inspecting operation to the image forming apparatus 100.

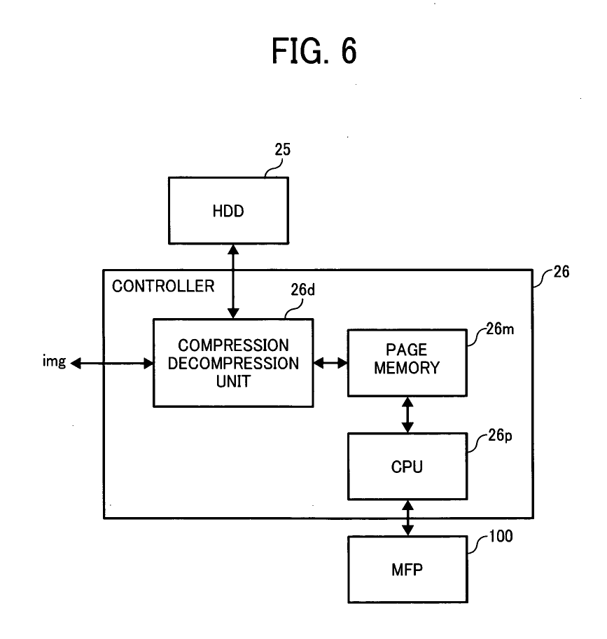

FIG. 6 shows a block diagram of the controller 26, which inputs and outputs data from/to the image forming apparatus 100, wherein such data may be inspection area data, for example. As shown in FIG. 6, the controller 26 may include a CPU 26p, a compression/decompression unit 26d, and a page memory 26m, for example. The controller 26 communicates data with an external apparatus for given purposes. For example, the controller 26 communicates data such as inspection result data with the image forming apparatus 100, which is an inspection target apparatus, or communicates data such as inspection result data with another external apparatus, which may use image inspection result for some purposes. As such, the controller 26 may receive inspection area data from the image forming apparatus 100, and transmit image inspection result data to the image forming apparatus 100, for example, but not limited these.

Further, the controller 26 can store image data “img” (e.g., reference image data and inspection image data) to the HDD 25. For example, when image data is generated using scanner-input image data, such scanner-input image data is transmitted to the controller 26 via a bus. When an image inspecting operation is to be conducted later, the stored image data is read-out from the HDD 25, and the compression/decompression unit 26d decompress the image data to original image data for each color (e.g., 8-bit data), and stores the decompressed image data in the page memory 26m as bitmap data, and then the image data is used for given processes or operations.

As above described, the image inspection apparatus 200 may receive the inspection area data from the image forming apparatus 100. Instead of such configuration, the image inspection apparatus 200 can generate inspection area data by itself, in which source image data is transmitted from the image forming apparatus 100 and the inspection area data is prepared in the image inspection apparatus 200. Further, the image inspection apparatus 200 may generate data related to an image inspecting operation such as image inspection result having bibliographic information. Such data prepared in the image inspection apparatus 200 is processed by the CPU 26p of the controller 26, and stored in the HDD 25. When such data is to be stored in the HDD 25, data may be compressed by the compression/decompression unit 26d, as required.

A description is now given to an image inspection function performed by the controller 26 of the image inspection apparatus 200 with reference to FIG. 7. FIG. 7 shows a functional configuration of the controller 26 used for image inspection function. As shown in FIG. 7, the image inspection function may be configured with an inspection area determination unit 261, a first color extraction unit 263, which may be referred to as a reference color extraction unit, a second color extraction unit 265, which may be referred to as an inspection color extraction unit, and an image quality judgment unit 267, for example. As such, the controller 26 may function as the first color extraction unit 263, the second color extraction unit 265, and the image quality judgment unit 267. In such configuration, a source image data 82, a reference image data 81 and an inspection image data 83 may be used as input image data when an image inspecting operation is conducted.

The source image data 82, which is one of input image data, is an original image data used for printing or outputting an image on sheets (e.g., paper, film, plate). The source image data 82 is used to print or output a reference document and an inspection document as above described. The source image data 82 may be digitized image data, wherein an image is composed of pixels, and each of pixels is positioned at a given position in an image and is assigned with given color data. A user (or operator) can select any image as source image data for image inspecting operation. Because the source image data is used as original or source data for image printing or outputting, image data size may become greater in some cases. In such cases, the original or source data may be digitally processed to trim the size of image data as similar to trimming size of image data for displaying purpose.

The reference image data 81 and inspection image data 83 can be used as input images for conducting an image inspecting operation. The reference image data 81 may be prepared as below. For example, the image forming apparatus 100 outputs or prints an image on a sheet using the source image data 82 to prepare a “reference document or reference document image,” in which the image forming apparatus 100 is used to produced an reference image as “reference document or reference document image.” Hereinafter, the term of reference document may be used. Then, the scanner 21 of the image inspection apparatus 200 scans the reference document. The scan-input image data is processed by the scanner correction unit 22 to prepare image data such as general-purpose RGB data. Such image data is used as the reference image data 81.

The inspection image data 83 may be prepared as below. An inspection-target image forming apparatus outputs or prints an image on a sheet using the source image data 82 to prepare an “inspection document or inspection document image.” Hereinafter, the term of inspection document may be used. In an example embodiment, the image forming apparatus 100 may also be used as an inspection-target image forming apparatus. As similar to the reference document, the inspection document is scanned by the scanner 21 of the image inspection apparatus 200 and processed by the scanner correction unit 22 to prepare the inspection image data 83.

As such, the image inspection function or operation may be configured with the inspection area determination unit 261, the first color extraction unit 263, the second color extraction unit 265, and the image quality judgment unit 267, for example.

The inspection area determination unit 261 determines an inspection area based on the source image data 82. Inspection image may be composed of pixels, in which each of pixels is assigned with given color data. As for such inspection image, one or more colors may be designated or selected as inspection color, and a position of pixel having the inspection color is determined as an inspection area. Such inspection area on the inspection image may be expressed by coordinate data.

The first color extraction unit 263 extracts at least one color (referred to as first-extracted-color) from an inspection area in the reference image data 81, wherein the inspection area is determined by the inspection area determination unit 261. The second color extraction unit 265 extracts at least one color (referred to as second-extracted-color) from an inspection area in the inspection image data 83, wherein the inspection area is determined by the inspection area determination unit 261. The first-extracted-color and the second-extracted-color are corresponded to the inspection color. The image quality judgment unit 267 compares the first-extracted-color extracted by the first color extraction unit 263 and the second-extracted-color extracted by the second color extraction unit 265, and determines whether a difference of the first-extracted-color and second-extracted-color is within a given range. If a difference is within the given range, it is judged that the image quality of inspection document is acceptable level.

The inspection area determination unit 261, the first color extraction unit 263, the second color extraction unit 265, and the image quality judgment unit 267 will be further described later with reference to a flowchart of image inspecting operation.

A description is now given to a flowchart of image inspection processing with reference to FIG. 8. FIG. 8 shows a flowchart of image inspection processing conducted by the controller 26.

At step S101, at least one color is designated (or selected) as an inspection color, in which at least one color is extracted as an inspection color to designate (or select) an inspection area later. Such step of designating the inspection color is implemented so that pixels having the designated color can be extracted from the source image data 82 and position data of such pixels can be determined. With such process, color information used for the image inspection can be based on data included in the source image data, which includes originally prepared image data.

The inspection color can be designated and determined as below, for example. In one case, an inspection color can be set using position data in one inspection image, in which a user (or operator) designates a position data (e.g., coordinate data) set for the inspection image in advance to read-out color data from such designated position in the source image data 82, stored in the HDD 25 of the image inspection apparatus 200. As such, the inspection color can be designated (or selected) by selecting a given position in one inspection image.

In an example embodiment, the controller 26 may be used as an inspection color designating unit to designate at least one inspection color, wherein the inspection color is selectable from colors included in the source image data. The controller 26 may also be used an inspection area determination unit (see an inspection area determination unit 261 in FIG. 7) to extract an image that is drawn by the inspection color from the source image data, and to set a one area in the extracted image as an inspection area, which is defined by coordinate data.

Further, the inspection color can be designated automatically without an instruction of a user (or operator) as below. For example, the inspection color can be determined automatically based on histogram data of the source image data 82, in which appearance frequency of each of colors is computed and stored, and one or more colors having greater appearance frequency may be selected as inspection color. In another case, a print command, input via the NIC 12 for performing an image outputting process using a printer function, may be analyzed before preparing bitmap data, and at least one color may be selected as inspection color. Further, any colors can be selected as inspection color (black color can be also used as inspection color). If the inspection color is automatically selected, inspection quality can be maintained at a given preferable level because the inspection color can be designated by color itself. The inspection color can be set using a known method described in JP-2004-351814-A, for example.

At step S102, an inspection area is determined using the inspection color designated at step S101. At step S102, an image having the designated inspection color is extracted from the source image data 82, and the inspection area determination unit 261 determines a given portion in the extracted image as an “inspection area,” wherein the inspection area is expressed by coordinate data. When the inspection area having the designated inspection color is extracted, it is checked whether the extracted inspection area has a given size or greater. Because the image forming apparatus 100 and the image inspection apparatus 200 may have unique apparatus characteristics each other, a size (or pixel numbers) of inspection area may need to be adjusted in view of such apparatus characteristics. For example, the size of extracted inspection area may become set to a relatively greater size, for example.

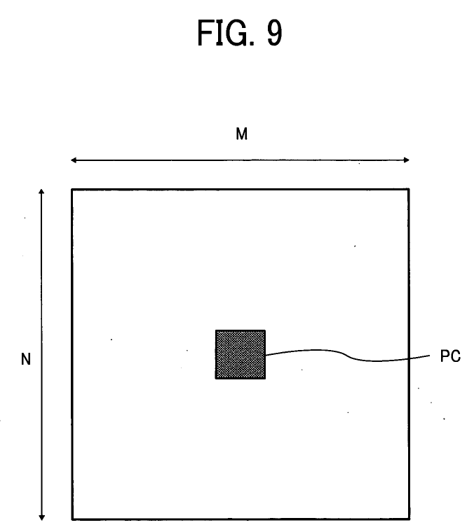

The image forming apparatus 100 (used as printing apparatus) prints an image on a sheet, in which a same image may be printed on a plurality of sheets while maintaining printing position of a same image at the same position over the plurality of sheets. However, an image may not be printed on a same position over the plurality of sheets due to some reasons, and tiny positional deviation of printing position of image may occur over a plurality of sheets. Further, when image-printed sheets having such positional deviation are scanned by the image inspection apparatus 200, image scanning position scanned by the scanner 21 may deviate among a plurality of sheets. As such, a scan-position deviation error for image scanning may occur for the reference image data 81 and the inspection image data 83. To reduce an effect of such positional deviation, an inspection area having a given size or more may be extracted from the source image data 82, the reference image data 81, and the inspection image data 83. For example, such given size may be “M×N” as shown in FIG. 9, wherein M and N may be set to odd number to set a concerned pixel Pc (center pixel) to an integral number, for example. As such, the inspection area may have a given minimum area size.

Further, when the reference image data 81 and the inspection image data 83 are output as images on sheets, the reference image data 81 and the inspection image data 83 may receive grayscale processing by the printing correction unit 8. Accordingly, to reduce an effect of grayscale processing, the size of “M×N” may be preferably set greater in view of averaging process for the concerned pixel Pc (center pixel) and surrounding pixels.

Specifically, when one designated inspection color is extracted from the source image data 82, a concerned pixel having the extracted inspection color and surrounding pixels having a size of M×N receives a given processing. When a result of given processing indicates that such pixels has the inspection color, the image area having M×N size is determined as an inspection area.

For example, as shown in FIG. 9, a concerned pixel Pc (center pixel) of inspection color is extracted, and a given processing is implemented for the concerned pixel Pc and surrounding pixels having M×N size. When a result of given processing of M×N pixels indicates that the concerned pixel Pc and surrounding pixels have the inspection color, an image area surrounding the concerned pixel Pc can be set as an inspection area having the extracted inspection color. In such a case, an inspection area may have a size defined by (M−1)/2 and (N−1)/2. Further, when the extracted image has a data size defined by M+a and N+b, an image size of M×N may be defined by 1+a and 1+b, in which “a” and “b” are set to even number to set an integral number for the concerned pixel Pc. When the inspection area is determined as such, the concerned pixel Pc and surrounding pixels set with a substantially same color, by which image inspection can be conducted without problem even if the above-described positional deviation occurs.

A position of inspection area on an image (coordinate data) may be set on any positions in an area obtained by conducting a given processing for pixels having M×N size. Preferably, the concerned pixel Pc may be extracted from a center of image area. Further, an inspection area may be determined based on an image area size, for example. Further, if a plurality of inspection areas for one inspection color is extracted, variation in one inspection image can be checked, which is preferable for maintaining precision of image inspecting operation. In such a case, a plurality of image areas may be selected as inspection areas, and position data of image area is used to determine position of the plurality of image areas.

Based on the inspection area determined at step S102, a first color corresponding to the inspection area is extracted from the reference image data 81 at step S103. As such, at step S103, the first color extraction unit 263 extracts a color corresponding to the inspection color from the inspection area of reference image data 81. Such extracted color may be referred to as first-extracted-color, hereinafter. The reference image data 81 may be stored in the HDD 25, for example. At step S103, the first-extracted-color data corresponding to the position of inspection area (expressed by coordinate data) is extracted from the reference image data 81. The inspection area may be determined based on the source image data 82, which may be 8-bit image data for RGB color stored in the HDD 25.

When extracting the first-extracted-color data, one pixel data is scanned with surrounding pixels data in the inspection area, determined from the source image data 82, and one pixel data and surrounding pixels data may receive an averaging process and then be extracted. Such averaging process using surrounding pixel data may be implemented to reduce an effect of grayscale processing of the scanner correction unit 22 and to reduce an effect of foreign materials and noise factors, which may occur when image data is prepared by scanning a document image. If only one pixel data is scanned, such unfavorable effect may occur.

At step S104, a data integrity check may be performed for image data, which is input as first-extracted-color data of the reference image data 81. The step S104 may be performed when image data is extracted from a plurality of inspection areas in the reference image data 81. In such data integrity check, it is checked whether the first-extracted-color data scanned from the plurality of inspection areas has a substantially same value. Specifically, the first-extracted-color data scanned from the plurality of inspection areas are compared each other, and if it is determined that a comparison result is within a given allowable range, it is determined that the first-extracted-color data scanned from the plurality of inspection areas has the substantially same value, by which it is determined the first-extracted-color data can be used as normal data, which can be used for an image inspecting operation. On one hand, if it is determined that a comparison result is not within a given allowable range, it is determined that the first-extracted-color data scanned from the plurality of inspection areas does not have the same value, by which it is determined the first-extracted-color data is abnormal data, which cannot be used for an image inspecting operation.

When it is determined that the first-extracted-color data is normal data, a next process of extracting a color corresponding to the inspection color from the inspection image data 82 can be further conducted. On one hand, when it is determined that the first-extracted-color data is abnormal data, an image inspecting operation is suspended and cancelled, and such abnormal condition is reported to an user (or operator). As such, the controller 26 may function as an extracted color check unit to check whether the first-extracted-color extracted from the plurality of inspection areas has a substantially same color. Further, the controller 26 may function as an inspection canceling unit to cancel an image inspecting operation.

The first-extracted-color data scanned from the plurality of inspection areas in the reference image data 81 may have a same level of color quality. However, due to an effect of image processing conducted for preparing the reference image data 81, data integrity of the reference image data 81 may become out of an allowable level, which may be referred as error effect of data integrity. Accordingly, by performing the data integrity check for first-extracted-color data extracted from a plurality of inspection areas, an image inspecting operation can be performed without receiving the above-mentioned error effect, which may occur when preparing the reference image data 81. Further, such error effect may occur when a given process is implemented before step S104 for an image inspecting operation.

Based on the inspection area determined at step S102, a color corresponding to the inspection color is extracted from the inspection image data 83 at step S105. At step S105, the second color extraction unit 265 extracts a color corresponding to the inspection color of the inspection area of the inspection image data 83 as second-extracted-color. The second color extraction unit 265 conducts such extraction process to the inspection image data 83 as similar to the first color extraction unit 263. Accordingly, the detail of extraction process of the second color extraction unit 265 is omitted.

At step S105, data integrity check is not performed for the second-extracted-color data, extracted from the inspection area of the inspection image data 83 by the second color extraction unit 265. Data integrity check is performed for the first-extracted-color image data extracted from a plurality of the inspection areas by the first color extraction unit 263 as above described. Such data integrity check is not performed at step S105 because step S105 is performed after step S104 that determines image data of the reference image data 81 has passed the data integrity check, and because a next step S106 determines whether abnormal condition such as error on image data occurs based on an image quality judgment result. At step S106, image quality of inspection image data 83 is checked, by which abnormal condition (e.g., error condition) of inspection image data 83, which may occur when extracted by the second color extraction unit 265, can be confirmed at step S106.

At step S106, image quality of inspection document output by an inspection-target image forming apparatus is determined. As above described, the image forming apparatus 100 may be used as an inspection-target image forming apparatus, for example. At step S106, the image quality judgment unit 267 determines whether image quality of the inspection document is acceptable.

At step S106, the second-extracted-color data extracted from the inspection image data 83 at step S105 is compared with the first-extracted-color data extracted from the reference image data 81 at step S103. Then, a comparison result is computed as difference of image data, and it is checked whether the computed difference of image data is within a given range. Such image quality judgment may be conducted as below. Comparison of first-extracted-color and second-extracted-color data is conducted for each one of pixels of the first-extracted-color and second-extracted-color data, wherein each one of pixels may have a corresponding same position data in the inspection area expressed by coordinate data.

Further, image quality judgment may be conducted as below. When comparison results (e.g., difference of image data) of first-extracted-color and second-extracted-color data for all pixels is within a given range, it is determined that the extracted color data is normal and acceptable level; when at least one of comparison result (e.g., difference of image data) of first-extracted-color and second-extracted-color data is not within a given range, it is determined that the extracted color data is abnormal and non-acceptable level.

In the above-described embodiment, color data used for image inspecting operation may use RGB data, for example. However, other color space can be used, as required. For example, general-purpose color space format used for printing such as PDF (Portable Document Format)/X3(ISO 15930-3) can be used, but not limited these.

In the above-described embodiment, one inspection color and a plurality of inspection areas may be extracted for an image inspecting operation. Further, a plurality of inspection colors can be extracted for an image inspecting operation, as required. For example, when an image of beach or sea scene is to be inspected, three colors such as color of sky, color of sea, and color of sand beach may be designated as inspection colors. Then, the above-described process for image inspecting operation can be conducted for each of three colors.

As above described, the image inspection method according to an example embodiment can be conducted as follows: the source image data 82 is used to output an image on a sheet such as reference document and inspection document, and then the reference document and inspection document are scanned by the same image inspection apparatus 200 to prepare the reference image data 81 and the inspection image data 83. Then, an inspection area for image inspecting operation is determined using at least one color included in the source image data 82 as an inspection color. Then, the first-extracted-color data is extracted from the reference image data 81, and the second-extracted-color data is extracted from the inspection image data 83. The first-extracted-color data extracted from the reference image data 81 is compared with the second-extracted-color data extracted from the inspection image data 83. With such image inspection method, image quality judgment can be conducted with an enhanced precision.

Further, in an example embodiment, an image inspecting operation can be conducted without using a specially-prepared test image pattern data such as color patch image, but the image inspecting operation can be conducted using any image data included in the source image data. Accordingly, an inspection-target image forming apparatus may not need to prepare a specially-prepared data and conduct a special process even if an image inspecting operation is conducted, by which an image forming apparatus can continue a printing operation without an interruption even if an image inspecting operation is conducted during image forming operation, and thereby an output performance of image forming apparatus can be enhanced.

In the above-described image inspecting operation, the first-extracted-color data of the reference image data 81 and the second-extracted-color data of the inspection image data 83 are compared each other at a corresponding same position in the inspection area. If a comparison result exceeds a given allowable range, it is determined that an image inspection result is not acceptable level. Such not-acceptable condition of image inspection result may occur by given factors such as “performance variation due to apparatus-to-apparatus characteristics variation” of image forming apparatus, and “over-time-characteristics-variation” of one image forming apparatus. Such factors may be categorized into a cause-result factor and a sporadic factor.

In case of cause-result factor, causes may be known for some cases. Accordingly, if a correction process is known for a given cause, the correction process can be conducted for the image forming apparatus 100. With such correction process, the image forming apparatus 100 can be controlled to output normal image. For example, when a not-acceptable condition is confirmed based on image inspection result obtained by a comparison of the first-extracted-color and second-extracted-color, an image concentration of printed image may become out of a median value (or target value), which means abnormal data is obtained. Such image inspection result is transmitted to the controller 6 of the image forming apparatus 100 as “imaging-condition correction data,” and upon receiving such imaging-condition correction data, the controller 6 can implement a correction process using the printing correction unit 8, for example. A process for correcting image concentration may be conducted by a known method described in JP-2002-301807-A, for example. By applying such correction method when receiving the above-described abnormal data, the image forming apparatus 100 can be controlled to output normal image based on the image inspection result data.

Further, when an image inspection result indicates image concentration of printed image is too low compared to a preferable image concentration level, and the printed image quality is not acceptable level for use, such abnormal printed image can be preferably separated or sorted from normal printed images. Such separation or sorting may be effectively conducted when abnormal printed image occurs due to a sporadic factor. Specifically, when such image inspection result indicating abnormal printed image is transmitted to the controller 6 of image forming apparatus 100 as a control signal, the controller 6 implements separation or sorting of abnormal printed image from normal printed image. In such a situation, the controller 6 may function as a sorting unit, for example. Such separation or sorting process can be conducted by a known method described in JP-4068210-B, for example. Such separation or sorting process can be effectively used when images are printed in a large scale continuously (e.g., catalog printing), for example. By applying such separation or sorting method when receiving the above-described abnormal data, the image forming apparatus 100 can be controlled to output normal image based on the image inspection result data. As such, the above-described image quality inspection may be preferably applied to image forming apparatuses, which produce images continuously. For example, the above-described image quality inspection can be preferably applied for a commercial printing industry, which needs to produce printing materials (e.g., catalogues, brochures, direct mails) in a large scale while maintaining higher image quality for printing materials.

In the above-described exemplary embodiments, a computer can be used with a computer-readable program to control functional units used for an image inspection system or apparatus. For example, a particular computer may control the image forming apparatus and the image inspection system or apparatus using a computer-readable program which can execute the above-described processes or steps. Further, in the above-described exemplary embodiments, a storage device (or recording medium), which can store computer-readable program, may be a flexible disk, a CD-ROM (compact disk read only memory), a memory card, a memory chip, or the like, but not limited these. Further, a computer-readable program can be downloaded to a particular computer (e.g., personal computer) via a network, or a computer-readable program can be installed to a particular computer from the above-mentioned storage device, by which the particular computer may be used for the image inspection system or apparatus according to exemplary embodiments, for example.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image inspection system for conducting an image inspecting operation to inspect image quality of a document image prepared by an image forming apparatus using source image data, the image inspecting operation conductable by preparing a reference document image and an inspection document image from the source image data, the image inspection system comprising:
a scanner to scan the reference document image to prepare reference image data and to scan the inspection document image to prepare inspection image data;
a storage unit to store at least the source image data;
an inspection color designating unit to designate at least one inspection color selectable from colors included in the source image data;
an inspection area determination unit to extract an image that is drawn by the inspection color from the source image data stored in the storage unit and set at least one area in the extracted image as an inspection area, coordinates of the inspection area being used for the image inspecting operation;
a reference color extraction unit to extract an image from the reference image data at a position in the reference image data corresponding to the inspection area set by the inspection area determination unit, the extracted image including a first-extracted-color corresponding to the inspection color, the first-extracted-color being used as a reference color for the image inspecting operation;
an inspection color extraction unit to extract an image from the inspection image data at a position in the inspection image data corresponding to the inspection area set by the inspection area determination unit, the extracted image including a second-extracted-color corresponding to the inspection color; and
an image quality judgment unit to determine whether an image quality of the inspection document image is acceptable by comparing the first-extracted-color and the second-extracted-color and determining whether a difference in image quality between the first-extracted-color and the second-extracted-color is within a given range.

2. The image inspection system according to claim 1, wherein the inspection area determination unit sets a given minimum area size for the inspection area to reduce an effect of scan-position deviation error between the reference document and the inspection document, the scan-position deviation error occur-able when the reference document and the inspection document are scanned by the scanner.

3. The image inspection system according to claim 1, wherein the inspection area determination unit sets a plurality of inspection areas for the image inspecting operation,
the image inspection system further comprising:
an extracted color check unit to check whether the first-extracted-color extracted from the plurality of inspection areas is a substantially same color; and
an inspection canceling unit to cancel the image inspecting operation when the extracted color check unit determines the first-extracted-color extracted from the plurality of inspection areas is not a substantially same color.

4. The image inspection system according to claim 1, further comprising:
a sorting unit to sort an inspected document having an unacceptable level of image quality from an inspected document having an acceptable level of image quality based on an image quality judgment result of the image quality judgment unit.

5. The image inspection system according to claim 1, wherein imaging-condition correction data is prepared based on the image quality judgment result of the image quality judgment unit,
the image inspection system further comprising:
a data transmission unit to transmit the imaging-condition correction data to the image forming apparatus that prepared the inspection document image.

6. A method of inspecting image quality of document image prepared by an image forming apparatus using source image data, the method comprising the steps of:
preparing a reference document image with the image forming apparatus using the source image data;
preparing an inspection document image with the image forming apparatus using the source image data;
storing the source image data in a storage unit;
selecting at least one color included in the source image data as an inspection color used for an image inspecting operation;
extracting an image that is drawn by the inspection color from the source image data stored in the storage unit;
setting a one area in the extracted image drawn by the inspection color as an inspection area;
scanning the reference document image using a scanner to prepare reference image data;
extracting an image from the reference image data at a position in the reference image data corresponding to the inspection area, the extracted image including a first-extracted-color being used as reference color for an image inspecting operation;
scanning the inspection document image using the scanner to prepare inspection image data;
extracting an image from the inspection image data at a position in the inspection image data corresponding to the inspection area, the extracted image including a second-extracted-color used for the image inspecting operation;
comparing the first-extracted-color and the second-extracted-color; and
determining whether an image quality of the inspection document image is acceptable by determining whether a difference in image quality between the first-extracted-color and the second-extracted-color is within a given range.

7. A computer-readable medium storing a program for inspecting image quality of a document image prepared by an image forming apparatus using source image data, the program comprising instructions that when executed by a computer cause the computer to execute a method of inspecting the image quality of the document image, the method comprising the steps of:
preparing a reference document image with the image forming apparatus using the source image data;
preparing an inspection document image with the image forming apparatus using the source image data;
storing the source image data in a storage unit;
selecting at least one color included in the source image data as an inspection color used for an image inspecting operation;
extracting an image that is drawn by the inspection color from the source image data stored in the storage unit;
setting a one area in the extracted image drawn by the inspection color as an inspection area;
scanning the reference document image using a scanner to prepare reference image data;
extracting an image from the reference image data at a position in the reference image data corresponding to the inspection area, the extracted image including a first-extracted-color being used as reference color for an image inspecting operation;
scanning the inspection document image using the scanner to prepare inspection image data;
extracting an image from the inspection image data at a position in the inspection image data corresponding to the inspection area, the extracted image including a second-extracted-color used for the image inspecting operation;
comparing the first-extracted-color and the second-extracted-color; and
determining whether an image quality of the inspection document image is acceptable by determining whether a difference in image quality between the first-extracted-color and the second-extracted-color is within a given range.
